(19) United States
(12) Patent Application Publication
(10) Pub. No.: US 2010/0027797 A1
(43) Pub. Date: Feb. 4, 2010

(54) Playing Apparatus and Management Method

(75) Inventor: Atsushi Nakamura, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/504,558

(22) Filed: Jul. 16, 2009

(30) Foreign Application Priority Data
Jul. 31, 2008 (JP) 2008-198743

(51) Int. Cl. H04L 9/00

(52) U.S. Cl. 380/277

(57) ABSTRACT

According to one embodiment, a playing apparatus reading a encrypted content and a content key configured to decrypt the encrypted content with use conditions set therein from a storage medium with the encrypted content and the content key for decrypting the encrypted content stored therein, decrypting the encrypted content by using the content key, and playing decrypted content, the apparatus includes a deletion module configured to delete the content key and the encrypted content from the storage medium with reference to the use conditions of the content key when the encrypted content is unable to be decrypted by using the content key.

### CROSS-REFERENCE TO RELATED APPLICATIONS

This application is based upon and claims the benefit of priority from Japanese Patent Application No. 2008-198743, filed Jul. 31, 2008, the entire contents of which are Incorporated herein by reference.

### BACKGROUND

1. Field

One embodiment of the invention relates to a playing apparatus and a content/content key management method which performs decryption in order to play encrypted content.

2. Description of the Related Art

A technique which voids or deletes a time-limited key after the lapse of a lending limit and prohibits browsing content as regards content which has been encrypted by the time-limited key including lending time limit information in lending content, such as an electronic book, is disclosed in Jpn. Pat. Appln. KOKAI Publication No. 2005-25438.

The technique disclosed in the document of the above poses the problem that content which cannot be browsed (played) remains and a source of a storage device of a playing apparatus is used wastefully.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram depicting a configuration of a content playing processing apparatus regarding one embodiment of the invention;

FIG. 2 is an exemplary view for explaining a procedure of deleting a content key and content regarding the one embodiment of the invention;

FIG. 3 is an exemplary view depicting an example of content and a content key stored in a medium; and

FIG. 4 is an exemplary view depicting a deletion example of the content and the content key stored in the medium.

### DETAILED DESCRIPTION

Various embodiments according to the invention will be described hereinafter with reference to the accompanying drawings. In general, according to one embodiment of the invention, a playing apparatus reading a encrypted content and a content key configured to decrypt the encrypted content with use conditions set therein from a storage medium with the encrypted content and the content key for decrypting the encrypted content stored therein, decrypting the encrypted content by using the content key, and playing decrypted content, the apparatus comprises a deletion module configured to delete the content key and the encrypted content from the storage medium with reference to the use conditions of the content key when the encrypted content is unable to be decrypted by using the content key.

An embodiment of the invention will be described with reference to the drawings.

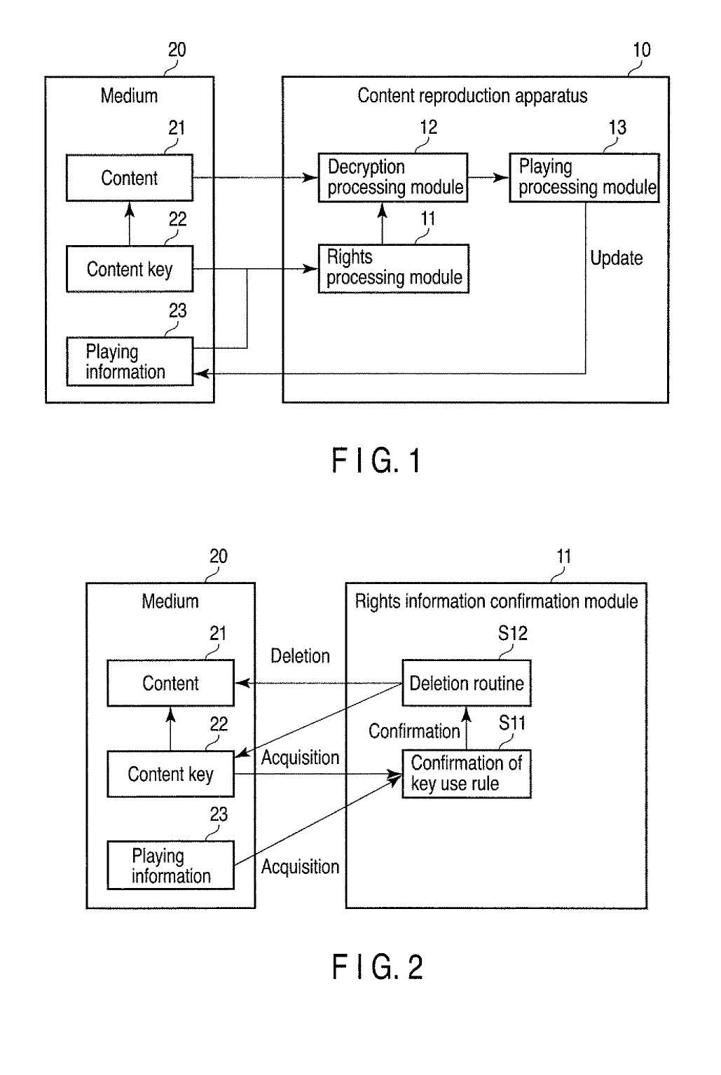

FIG. 1 shows a block diagram depicting a system configuration of a content playing apparatus regarding one embodiment of the invention.

A content playing apparatus 10 comprises a rights information confirmation module 11 which reads a content key 22 for decrypting content 21 stored in a medium 20 such as an SD card, and confirms rights information such as a playable time limit, the number of playable times, and a playable span (a playable interval from an initial playing start); a decryption processing module 12 which decrypts the content 21 stored in the medium 20 by using the content key 22; and a playing processing module 13 which plays the decrypted content 21. The playing processing module 13 stores information such as presence or absence of playing completion, an interruption position, etc., of the played content 21 in the medium 20 as playing information 23.

The rights information confirmation module 11 has a function of automatically deleting the content key 22 stored in the medium 20 when the content 21 cannot be decrypted by using the content key 22 stored in the medium 20 because of the elapse of the playable time limit.

The confirmation module 11 acquires the content key 22 and playing information 23 to confirm a use rule, as shown in FIG. 2 (Step S11). If the use rule shows a state in which the content 21 cannot be decrypted by the use of the content key 22, the confirmation module 11 deletes the content key 22 and the content 21 (Step S12).

The confirmation module 11 deletes the content key 22 on the basis of the rule expressed as follows:

1. If the content is rental content and the content cannot be played due to a condition such as a time limit and the number of playable times, the content key 22 is automatically deleted

2. In addition to the rule 1, the content 21 is also deleted

3. If there is a plurality of content keys 22, the rule 2 is not applied, and if the content key becomes the last one, the rule 2 is applied.

An example of the deletion of the content key 22 and the content 21 on the basis of the rules 1-3 of the above will be described hereinafter.

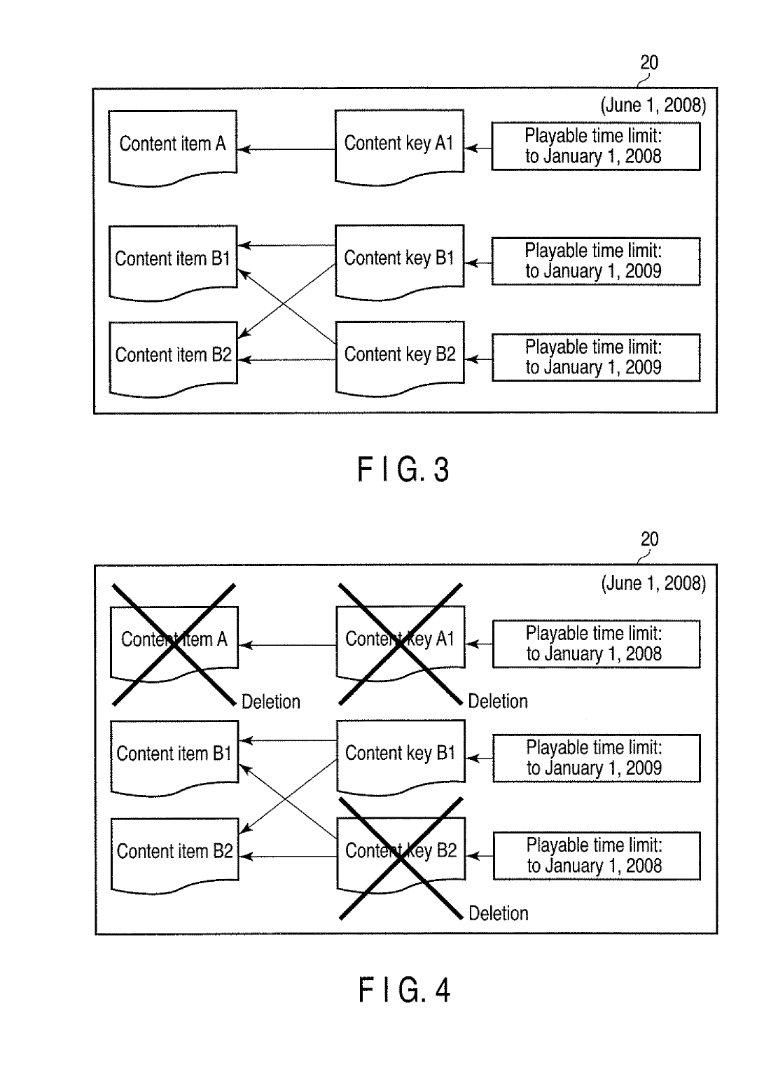

FIG. 3 shows a state of the content 21 and the content key 22 stored in the medium 20. It is assumed that to decrypt content item A, a content key A1 is used, and to decrypt content items B1, B2, content keys B1, B2 are used, respectively. And it is assumed that today is Jun. 1, 2008.

The content key A1 is set with a playable time limit (Jan. 1, 2008). Content key B1 is set with a playable time limit (Jan. 1, 2009). Content key B2 is set with a playable time limit (Jan. 1, 2009).

When the playable time limit has elapsed, the number of playable times “0”, or the playable span has elapsed, the confirmation module 11 deletes the content key 22, as shown in FIG. 4. The confirmation module 11 also deletes a file of the content 21 of which the content key 22 enabling the content to be decrypted is not present in the medium 20.

For instance, if it is assumed that today is Jun. 1, 2008, it is impossible to decrypt content item A by using content key A1 of which the playable time limit is set to Jan. 1, 2008. In this case, the confirmation module 11, as shown in FIG. 4, deletes the content key A1. The content key 22, which is able to decrypt the content item A, has been deleted and then the content item A cannot be decrypted. Therefore, the confirmation module 11 deletes the content key A1.

The content items B1, B2 cannot be decrypted by using content key B2 of which the playable time limit is set to Jan. 1, 2008. Therefore, as shown in FIG. 4, the confirmation module 11 deletes the content key B2. It is able to decrypt the content items B1, B2 by using the content key B1. Therefore, the confirmation module 11, as shown in FIG. 4, does not delete the content items B1, B2 differing from the case of deletion of the content item A and the content key A1. However, when the playable time limit (Jan. 1, 2009) which has been set with the content key B has lapsed, the confirmation module 11 deletes the content key B and the content items B1, B2.

Rules 4-6 defined as follows may be added to the rules 1-3 described above.

4. When deleting the content 21 of the rule 2, an additional condition is added.

For instance, if the content 21 is not played till the last in the rules 2, 3, the content 21 is not deleted.

Further, the rule 4 will be described hereinafter. When automatically deleting the content 21, there is a case in which a user does not desire to delete the content 21 on purpose even if the content 21 becomes unable to be played because the key itself has been deleted. For instance, if the user rents the content 21, the user may get the key again.

If the playable time limit has lapsed in a state in which the user has not completed to view the content 21 itself, the user can play the content 21 by purchasing only the key of the content 21 after the elapse of playable time limit. If the content 21 has been deleted, the user has to get the content 21 through downloading, etc., when the user gets again the key for playing. Therefore, the user can view the content 21 under an image which is almost the same as extension of a time limit of a rental video as we know it today. It is also acceptable not to delete a specified time period after deleting the key.

5. The user may select the combination of rule 4 represented as follows:

(a) Delete or not delete the content key 22

(b) Condition in a case of deletion in (a), (e.g., the playable time limit has lapsed)

(c) Delete or not delete the content 21

(d) Condition in a case of deletion of the content 21, (e.g., the content 21 has been viewed till the last). Conversely, the content 21 has been viewed many times (there is high possibility to view the same content 21 in the future).

6. In the same conditions as a case in which the content 21 is not deleted under the rule 4, the (extended) rental or purchase of the content key 22 may be presented again to the user.

For instance, the deletion of the content 21 under the rule 4 is a technique which does not delete the content 21 even if the content key 22 is deleted because there is a possibility for the user to still view the content 21; however, when it is determined not to delete the content 21, the confirmation module 11 may simultaneously report the extending the rental or purchasing the content 21 to the user by means of displaying the fact on a display provided for the playing apparatus 10.

As mentioned above, the apparatus 10 can automatically delete the content which is impossible to be played, and increase the capacity of the storage device.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A playing apparatus reading a encrypted content and a content key configured to decrypt the encrypted content with use conditions set therein from a storage medium with the encrypted content and the content key for decrypting the encrypted content stored therein, decrypting the encrypted content by using the content key, and playing decrypted content, the apparatus comprising:
a deletion module configured to delete the content key and the encrypted content from the storage medium with reference to the use conditions of the content key when the encrypted content is unable to be decrypted by using the content key.

2. The apparatus of claim I, wherein
the deletion module does not delete the encrypted content if use conditions, which is set in another content key able to decrypt the encrypted content, shows possibility to decrypt the content corresponding to the content key to be deleted when deleting a content key unable to decrypt the encrypted content.

3. The apparatus of claim 1, wherein
the storage medium stores playing information showing whether or not the encrypted content has been played completely; and
the deletion module does not delete the encrypted content when the playing information shows that the content has not been played completely.

4. The apparatus of claim 3, further comprising:
a presentation module configured to present getting a new content key which decrypts the not deleted encrypted content to a user.

5. The apparatus of claim 1, wherein
the storage medium stores playing information which shows the number of playable times of the encrypted content; and
the deletion module does not delete the content if the number of the playable times exceeds a set value.

6. A content/content key management method of a playing apparatus reading a encrypted content and a content key configured to decrypt the encrypted content with use conditions set therein from a storage medium with the encrypted content and the content key for decrypting the encrypted content stored therein, decrypting the encrypted content by using the content key, and playing the decrypted content, comprising:
deleting the content key and the encrypted content from the storage medium when the encrypted content being unable to be decrypted by using the content key with reference to the user conditions of the content key.

7. The method of claim 6, further comprising:
not deleting the encrypted content if use conditions, which is set in another content key able to decrypt the encrypted content, shows possibility to decrypt the encrypted content corresponding to the content key to be deleted when deleting a content key unable to decrypt the encrypted content.

8. The method of claim 6, further comprising:
storing playing information showing whether or not the content has been played completely; and
not deleting the content when the playing information shows that the encrypted content has not been played completely.

9. The method of claim 8, further comprising:
presenting of getting of a new content key configured to decrypt which has not been deleted the encrypted content to a user.

10. The method of claim 6, further comprising
storing playing information which shows the number of playable times of the content; and
not deleting the encrypted content when the number of the playable times exceeds a set value.
